(19) United States
(12) Patent Application Publication
(10) Pub. No.: US 2023/0399821 A1
(43) Pub. Date: Dec. 14, 2023

(54) WORK MACHINE, SYSTEM INCLUDING WORK MACHINE, AND METHOD OF CONTROLLING ISSUANCE APPARATUS

(71) Applicant: KOMATSU LTD., Minato-ku, Tokyo (JP)

(72) Inventor: Kazumichi OKAJIMA, Minato-ku, Tokyo (JP)

(73) Assignee: KOMATSU LTD., Minato-ku, Tokyo (JP)

(21) Appl. No.: 18/036,454

(22) PCT Filed: Nov. 2, 2021
(86) PCT No.: PCT/JP2021/040356

§ 371 Date: May 11, 2023

(30) Foreign Application Priority Data
Dec. 7, 2020 (JP) 2020-202718

(51) Int. Cl. E02F 9/26; E02F 9/20; E02F 9/22

(52) U.S. Cl. CPC E02F 9/265; E02F 9/2004; E02F 9/2214; E02F 9/2271; E02F 9/2285; E02F 9/2296

(57) ABSTRACT

A work machine capable of suppressing a piston of a hydraulic cylinder reaching a stroke end is provided. The work machine includes a vehicular body, a work implement supported on the vehicular body, a hydraulic cylinder that drives the work implement, an issuance apparatus that issues a warning, and a controller that controls the hydraulic cylinder and the issuance apparatus. The hydraulic cylinder includes a cylinder portion and a piston capable of carrying out reciprocating movement within the cylinder portion. The controller can control the issuance apparatus to issue a warning when the piston reaches a warning issuance position before the stroke end of the hydraulic cylinder, and can adjust timing of issuance of the warning.

### TECHNICAL FIELD

The present disclosure relates to a work machine, a system including a work machine, and a method of controlling an issuance apparatus.

### BACKGROUND ART

Japanese Patent Laying-Open No. 11-158930 (PTL 1) proposes an apparatus as below. A front apparatus is provided in front of a revolving unit of a hydraulic excavator. The front apparatus is composed of a boom, an arm, and a bucket each pivotable in an upward/downward direction. The boom, the arm, and the bucket are driven by a boom cylinder, an arm cylinder, and a bucket cylinder, respectively. As the cylinder comes closer to a stroke end, a warning is issued to notify an operator of that fact.

### CITATION LIST

### Patent Literature

PTL 1: Japanese Patent Laying-Open No. 11-158930

### SUMMARY OF INVENTION

### Technical Problem

Even when a less experienced operator recognizes a warning indicating approach of a piston of a hydraulic cylinder to a stroke end, it is difficult for the less experienced operator to prevent the piston from reaching the stroke end. As the piston physically hits the stroke end, noise is generated.

The present disclosure proposes a work machine, a system including a work machine, and a method of controlling an issuance apparatus that can achieve suppression of a piston of a hydraulic cylinder reaching a stroke end.

### Solution to Problem

According to the present disclosure, a work machine including a vehicular body, a work implement supported on the vehicular body, a hydraulic cylinder that drives the work implement, an issuance apparatus that issues a warning, and a controller that controls the hydraulic cylinder and the issuance apparatus is proposed. The hydraulic cylinder includes a cylinder portion and a piston capable of carrying out reciprocating movement within the cylinder portion. The controller controls the issuance apparatus to issue a warning when the piston reaches a warning issuance position before a stroke end of the hydraulic cylinder and adjusts timing of issuance of the warning.

### Advantageous Effects of Invention

According to the present disclosure, the piston of the hydraulic cylinder reaching the stroke end can be suppressed, and noise can be lowered.

### BRIEF DESCRIPTION OF DRAWINGS

FIG. 1 is a side view schematically showing a construction of a work machine based on an embodiment.

FIG. 2 is a block diagram showing a hydraulic circuit and an operation apparatus of the work machine shown in FIG. 1.

FIG. 3 is a diagram showing a functional block in a controller shown in FIG. 2.

FIG. 4 is a flowchart showing a flow in advance preparation processing for control of the work machine.

FIG. 5 is a flowchart showing a flow of processing for adjusting a warning issuance position based on a skill level of an operator.

FIG. 6 is a diagram showing an exemplary operation when a warning is issued to a skilled operator.

FIG. 7 is a diagram showing an exemplary operation when a warning is issued to a less experienced operator.

FIG. 8 is a flowchart showing a flow of processing in a sub routine for adjusting the warning issuance position shown in FIG. 5.

FIG. 9 is a flowchart showing a flow of processing for adjusting the warning issuance position based on a cylinder speed.

FIG. 10 is a diagram showing an exemplary operation when a cylinder speed is high.

FIG. 11 is a diagram showing an exemplary operation when the cylinder speed is low.

FIG. 12 is a diagram showing an exemplary warning issuance position and an exemplary stroke restriction position.

FIG. 13 is a flowchart showing a flow of processing for canceling stroke restriction control in accordance with an operator's intention during works.

FIG. 14 is a flowchart showing a flow of processing for canceling stroke restriction control in accordance with advance setting made by the operator.

FIG. 15 is a schematic diagram of a system including the work machine.

### DESCRIPTION OF EMBODIMENTS

An embodiment will be described below with reference to the drawings. The same elements in the description below have the same reference characters allotted and their labels and functions are also the same. Therefore, detailed description thereof will not be repeated.

In the description below, “upward”, “downward”, “front”, “rear”, “left”, and “right” refer to directions with an operator sitting in an operator's seat 2b in an operator's cab 2a being defined as the reference.

<Construction of Work Machine>

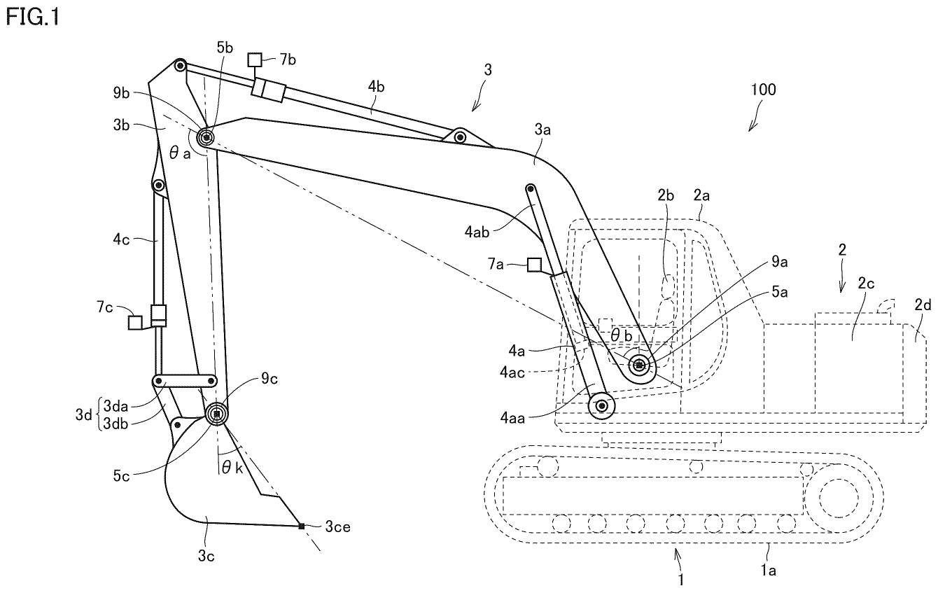

FIG. 1 is a side view schematically showing a construction of a hydraulic excavator 100 by way of example of a work machine based on an embodiment. As shown in FIG. 1, hydraulic excavator 100 in the present embodiment mainly includes a traveling unit 1, a revolving unit 2, and a work implement 3. A vehicular body of hydraulic excavator 100 is constituted of traveling unit 1 and revolving unit 2.

Traveling unit 1 includes a pair of left and right crawler belt apparatuses 1a. Each of the pair of left and right crawler belt apparatuses 1a includes a crawler belt. As the pair of left and right crawler belts is rotationally driven, hydraulic excavator 100 is self-propelled. Traveling unit 1 may include a wheel (tire) instead of crawler belt apparatuses 1a.

Revolving unit 2 is provided as being revolvable with respect to traveling unit 1. Revolving unit 2 mainly includes operator's cab (cab) 2a, operator's seat 2b, an engine compartment 2c, and a counterweight 2d. Operator's cab 2a is arranged, for example, on a front left side (a front side of a vehicle) of revolving unit 2. In an internal space in operator's cab 2a, operator's seat 2b where an operator takes a seat is arranged. Though hydraulic excavator 100 is operated from the inside of operator's cab 2a in the present disclosure, hydraulic excavator 100 may remotely be operated wirelessly from a location distant from hydraulic excavator 100.

Each of engine compartment 2c and counterweight 2d is arranged on a rear side of revolving unit 2 (on a rear side of the vehicle) with respect to operator's cab 2a. An engine unit (an engine, an exhaust treatment structure body, etc.) is accommodated in engine compartment 2c. An engine hood covers engine compartment 2c from above. Counterweight 2d is arranged in the rear of engine compartment 2c.

Work implement 3 is supported on revolving unit 2 on a front side of revolving unit 2, for example, on the right side of operator's cab 2a. Work implement 3 includes, for example, a boom 3a, an arm 3b, a bucket 3c, a boom cylinder 4a, an arm cylinder 4b, and a bucket cylinder 4c.

Boom 3a has a base end rotatably coupled to revolving unit 2 by a boom foot pin 5a. Arm 3b has a base end rotatably coupled to a tip end of boom 3a by an arm coupling pin 5b. Bucket 3c is rotatably coupled to a tip end of arm 3b by a bucket coupling pin 5c. Bucket 3c includes a plurality of blades. A tip end of bucket 3c is referred to as a cutting edge 3ce. Bucket 3c does not have to include a blade. The tip end of bucket 3c may be formed from a steel plate in a straight shape.

Boom 3a can be driven by boom cylinder 4a. By being driven, boom 3a can rotate relatively to revolving unit 2 around boom foot pin 5a. Arm 3b can be driven by arm cylinder 4b. By being driven, arm 3b can rotate relatively to boom 3a around arm coupling pin 5b. Bucket 3c can be driven by bucket cylinder 4c. By being driven, bucket 3c can rotate relatively to arm 3b around bucket coupling pin 5c.

Bucket 3c is an exemplary attachment removably attached to a tip end of work implement 3 and rotatable with respect to arm 3b. Depending on a type of works, the attachment is replaced with a breaker, a grapple, a lifting magnet, or the like.

Work implement 3 includes a bucket link 3d. Bucket link 3d includes a first link member 3da and a second link member 3db. First link member 3da and second link member 3db are coupled as being rotatable relative to each other. First link member 3da and second link member 3db are coupled to bucket cylinder 4c by means of a pin. First link member 3da is rotatably coupled to arm 3b. Second link member 3db is rotatably coupled to a bracket at a root of bucket 3c.

Boom cylinder 4a, arm cylinder 4b, and bucket cylinder 4c are each a hydraulic cylinder driven by hydraulic oil. As each of boom 3a, arm 3b, and bucket 3c is driven by a hydraulic cylinder, work implement 3 can operate. The hydraulic cylinder can drive work implement 3.

Boom cylinder 4a includes a cylinder portion 4aa, a rod 4ab, and a piston 4ac. Cylinder portion 4aa is cylindrical. Cylinder portion 4aa is rotatably connected to revolving unit 2 at cylindrically extending one end thereof. Piston 4ac is accommodated in a cylinder chamber in the inside of cylinder portion 4aa and can carry out reciprocating movement in a longitudinal direction (an axial direction) of cylinder portion 4aa within the cylinder chamber. Piston 4ac can carry out in cylinder portion 4aa, reciprocating motion between stroke ends which are terminal ends of a stroke in a direction of extension and contraction of boom cylinder 4a. Rod 4ab extends in the longitudinal direction of cylinder portion 4aa. Rod 4ab has a base end fixed to piston 4ac. Rod 4ab has a tip end rotatably connected to boom 3a.

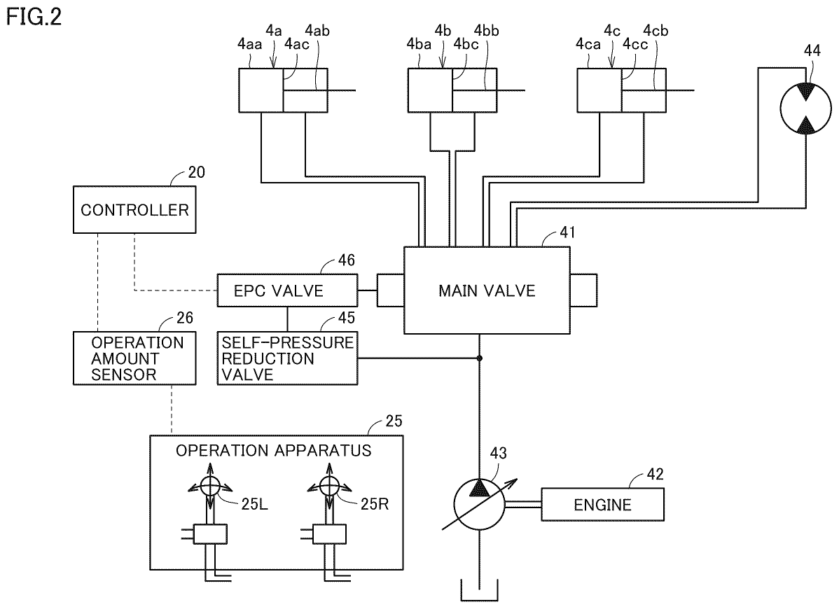

Arm cylinder 4b is constructed similarly to boom cylinder 4a and includes a cylinder portion 4ba, a rod 4bb, and a piston 4bc (not shown in FIG. 1, see FIG. 2). Piston 4bc can carry out in cylinder portion 4ba, reciprocating motion between stroke ends which are terminal ends of a stroke in the direction of extension and contraction of arm cylinder 4b. Bucket cylinder 4c is constructed similarly to boom cylinder 4a and includes a cylinder portion 4ca, a rod 4cb, and a piston 4cc (not shown in FIG. 1, see FIG. 2). Piston 4cc can carry out in cylinder portion 4ca, reciprocating motion between stroke ends which are terminal ends of a stroke in the direction of extension and contraction of bucket cylinder 4c.

A stroke sensor 7a is attached to boom cylinder 4a. Stroke sensor 7a detects an amount of displacement of piston 4ac with respect to cylinder portion 4aa in boom cylinder 4a. A stroke sensor 7b is attached to arm cylinder 4b. Stroke sensor 7b detects an amount of displacement of piston 4bc with respect to cylinder portion 4ba in arm cylinder 4b. A stroke sensor 7c is attached to bucket cylinder 4c. Stroke sensor 7c detects an amount of displacement of piston 4cc with respect to cylinder portion 4ca in bucket cylinder 4c.

An angle sensor 9a is attached around boom foot pin 5a. An angle sensor 9b is attached around arm coupling pin 5b. An angle sensor 9c is attached around bucket coupling pin 5c. Angle sensors 9a, 9b, and 9c may be implemented by potentiometers or rotary encoders.

As shown in FIG. 1, in a side view, an angle formed between a straight line (shown with a chain double-dotted line in FIG. 1) that passes through boom foot pin 5a and arm coupling pin 5b and a straight line (shown with a dashed line in FIG. 1) that extends in an upward/downward direction is defined as a boom angle θb. Boom angle θb represents an angle of boom 3a with respect to revolving unit 2. Boom angle θb can be calculated from a result of detection by stroke sensor 7a or from a measurement value from angle sensor 9a.

In the side view, an angle formed between the straight line that passes through boom foot pin 5a and arm coupling pin 5b and a straight line (shown with a chain double-dotted line in FIG. 1) that passes through arm coupling pin 5b and bucket coupling pin 5c is defined as an arm angle θa. Arm angle θa represents an angle of arm 3b with respect to boom 3a. Arm angle θa can be calculated from a result of detection by stroke sensor 7b or from a measurement value from angle sensor 9b. In the side view, an angle formed between the straight line that passes through arm coupling pin 5b and bucket coupling pin 5c and a straight line (shown with a chain double-dotted line in FIG. 1) that passes through bucket coupling pin 5c and cutting edge 3ce is defined as a bucket angle θk. Bucket angle θk represents an angle of bucket 3c with respect to arm 3b. Bucket angle θk can be calculated from a result of detection by stroke sensor 7c or from a measurement value from angle sensor 9c.

<Hydraulic Circuit and Operation Apparatus of Work Machine>

A hydraulic circuit and an operation apparatus of the work machine will now be described with reference to FIG. 2. FIG. 2 is a block diagram showing a hydraulic circuit and an operation apparatus of the work machine shown in FIG. 1.

An engine 42 is, for example, a diesel engine. As an amount of injection of fuel into engine 42 is controlled, output of engine 42 is controlled. A hydraulic pump 43 is coupled to engine 42. As rotational driving force of engine 42 is transmitted to hydraulic pump 43, hydraulic pump 43 is driven. Hydraulic pump 43 may be, for example, a variable displacement hydraulic pump that includes a swash plate and varies a delivery capacity by changing a tilting angle of the swash plate.

Some of oil delivered from hydraulic pump 43 is supplied to a main valve 41 as hydraulic oil. Remainder of oil delivered from hydraulic pump 43 is supplied for pilot use, with a pressure thereof being reduced to a certain pressure by a self-pressure reduction valve 45. Oil with the pressure thereof being reduced to a certain pressure by self-pressure reduction valve 45 is supplied to main valve 41 through an electromagnetic proportional control (EPC) valve 46.

EPC valve 46 receives a current command from controller 20. EPC valve 46 generates a pilot pressure in accordance with a current value in the current command. EPC valve 46 drives a spool of main valve 41 with the pilot pressure.

Boom cylinder 4a, arm cylinder 4b, bucket cylinder 4c, and a revolution motor 44 are connected to main valve 41 as hydraulic actuators. Revolution motor 44 rotates revolving unit 2 relatively to traveling unit 1. As the spool of main valve 41 axially moves, an amount of supply of hydraulic oil to each of hydraulic actuators is adjusted. Operations of work implement 3 and revolution of revolving unit 2 are thus controlled.

In the present example, oil supplied to hydraulic actuators for activating the hydraulic actuators is referred to as hydraulic oil. Oil supplied to a pressure reception chamber of main valve 41 for activating main valve 41 to drive the spool is referred to as pilot oil. A pressure of pilot oil is referred to as a pilot hydraulic pressure (PPC pressure).

Hydraulic pump 43 may deliver both of hydraulic oil and pilot oil as set forth above. Hydraulic pump 43 may include a hydraulic pump (a main hydraulic pump) that delivers hydraulic oil and a hydraulic pump (a pilot hydraulic pump) that delivers pilot oil separately from each other.

EPC valve 46 is controlled under a command from controller 20 based on an operation command from an operation apparatus 25. Based on an operation onto operation apparatus 25, various operations such as excavation, revolution of revolving unit 2 with respect to traveling unit 1, and ejection of loads from bucket 3c are performed.

Operation apparatus 25 is arranged in operator's cab 2a (FIG. 1). Operation apparatus 25 is operated by an operator. Operation apparatus 25 accepts an operation by the operator for driving work implement 3. Operation apparatus 25 accepts an operation by the operator for revolving revolving unit 2. Operation apparatus 25 is operated by the operator for driving the hydraulic cylinder.

Operation apparatus 25 includes a first control lever 25L and a second control lever 25R. First control lever 25L is arranged, for example, on the left side of operator's seat 2b (FIG. 1). Second control lever 25R is arranged, for example, on the right side of operator's seat 2b. Forward, rearward, left, and right operations onto first control lever 25L and second control lever 25R correspond to biaxial operations.

For example, arm 3b and revolving unit 2 are operated with the use of first control lever 25L. An operation in a front/rear direction onto first control lever 25L corresponds, for example, to revolution of revolving unit 2, and a right revolution operation and a left revolution operation of revolving unit 2 are performed in accordance with an operation in the front/rear direction. An operation in a lateral direction onto first control lever 25L corresponds, for example, to an operation of arm 3b, and an operation of arm 3b in a direction of dumping (upward) and a direction of excavation (downward) is performed in accordance with an operation in the lateral direction.

For example, boom 3a and bucket 3c are operated by operating second control lever 25R. An operation in the front/rear direction onto second control lever 25R corresponds, for example, to an operation of boom 3a, and an operation to lower and raise boom 3a is performed in accordance with an operation in the front/rear direction. An operation in the lateral direction onto second control lever 25R corresponds, for example, to an operation of bucket 3c, and an operation of bucket 3c in the direction of excavation (upward) and the direction of dumping (downward) is performed in accordance with an operation in the lateral direction.

An operation in the front/rear direction onto first control lever 25L may correspond to an operation of arm 3b, and an operation in the lateral direction onto the same may correspond to an operation of revolving unit 2. The operation in the lateral direction onto second control lever 25R may correspond to an operation of boom 3a, and an operation in the front/rear direction onto the same may correspond to an operation of bucket 3c.

Operation apparatus 25 provides an operation signal in accordance with an operation by an operator. An amount of operation onto operation apparatus 25 is sensed by an operation amount sensor 26 based on an operation signal provided from operation apparatus 25. Operation amount sensor 26 is implemented, for example, by a potentiometer or a hall element. A signal indicating an amount of operation sensed by operation amount sensor 26 is provided to controller 20. Controller 20 controls EPC valve 46 based on an operation command from operation apparatus 25 as set forth above.

Though operation apparatus 25 is, for example, an electric operation apparatus in the present example, the operation apparatus may be a pilot hydraulic operation apparatus. When operation apparatus 25 is a pilot hydraulic operation apparatus, an amount of operation onto operation apparatus 25 is sensed, for example, by a pressure sensor that senses a pressure of oil.

Controller 20 is implemented, for example, by a computer, a server, or a portable terminal, and includes a central processing unit (CPU), a memory, and a timer. Controller 20 may be mounted on hydraulic excavator 100 or may be provided at a remote location distant from hydraulic excavator 100.

<Functional Block in Controller 20>

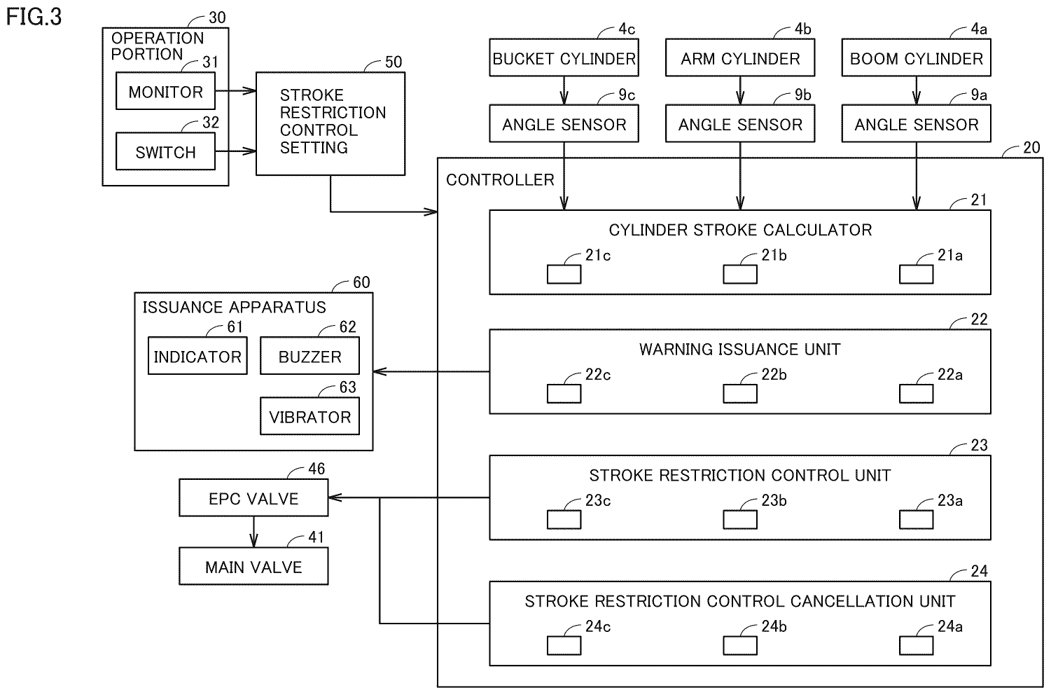

A functional block in controller 20 shown in FIG. 2 will now be described with reference to FIG. 3. FIG. 3 is a diagram showing a functional block in controller 20 shown in FIG. 2. As shown in FIG. 3, controller 20 includes a cylinder stroke calculator 21, a warning issuance unit 22, a stroke restriction control unit 23, and a stroke restriction control cancellation unit 24.

Cylinder stroke calculator 21 includes a boom calculator 21a, an arm calculator 21b, and a bucket calculator 21c.

Boom calculator 21a calculates a length of a range within which piston 4ac is movable in the longitudinal direction of cylinder portion 4aa of boom cylinder 4a (for example, a distance between the stroke end on an extension side and the stroke end on a contraction side, which will be referred to as a maximum stroke of boom cylinder 4a below) based on a result of detection by stroke sensor 7a attached to boom cylinder 4a. Boom calculator 21a finds a current position of piston 4ac in the longitudinal direction of cylinder portion 4aa of boom cylinder 4a based on a result of detection by stroke sensor 7a or correspondence with boom angle θb measured by angle sensor 9a.

Arm calculator 21b calculates a length of a range within which piston 4bc is movable in the longitudinal direction of cylinder portion 4ba of arm cylinder 4b (for example, a distance between the stroke end on the extension side and the stroke end on the contraction side, which will be referred to as a maximum stroke of arm cylinder 4b below) based on a result of detection by stroke sensor 7b attached to arm cylinder 4b. Arm calculator 21b finds a current position of piston 4bc in the longitudinal direction of cylinder portion 4ba of arm cylinder 4b based on a result of detection by stroke sensor 7b or correspondence with arm angle θa measured by angle sensor 9b.

Bucket calculator 21c calculates a length of a range within which piston 4cc is movable in the longitudinal direction of cylinder portion 4ca of bucket cylinder 4c (for example, a distance between the stroke end on the extension side and the stroke end on the contraction side, which will be referred to as a maximum stroke of bucket cylinder 4c below) based on a result of detection by stroke sensor 7c attached to bucket cylinder 4c. Bucket calculator 21c finds a current position of piston 4cc in the longitudinal direction of cylinder portion 4ca of bucket cylinder 4c based on a result of detection by stroke sensor 7c or correspondence with bucket angle θk measured by angle sensor 9c.

Warning issuance unit 22 includes a boom issuance unit 22a, an arm issuance unit 22b, and a bucket issuance unit 22c.

When piston 4ac of boom cylinder 4a reaches a warning issuance position, boom issuance unit 22a transmits a control signal to issuance apparatus 60 to have issuance apparatus 60 issue a warning. When piston 4bc of arm cylinder 4b reaches the warning issuance position, arm issuance unit 22b transmits a control signal to issuance apparatus 60 to have issuance apparatus 60 issue a warning. When piston 4cc of bucket cylinder 4c reaches the warning issuance position, bucket issuance unit 22c transmits a control signal to issuance apparatus 60 to have issuance apparatus 60 issue a warning.

Issuance apparatus 60 includes an indicator 61, a buzzer 62, a vibrator 63, and the like. Issuance apparatus 60 receives input of the control signal from warning issuance unit 22 and issues a warning to the operator. Vibrator 63 may be provided, for example, in first control lever 25L and second control lever 25R.

Stroke restriction control unit 23 includes a boom restriction unit 23a, an arm restriction unit 23b, and a bucket restriction unit 23c.

Boom restriction unit 23a controls piston 4ac of boom cylinder 4a not to reach the stroke end. Arm restriction unit 23b controls piston 4bc of arm cylinder 4b not to reach the stroke end. Bucket restriction unit 23c controls piston 4cc of bucket cylinder 4c not to reach the stroke end. Control of each of pistons 4ac, 4bc, and 4cc not to reach the stroke end is referred to as stroke restriction control below.

Stroke restriction control cancellation unit 24 includes a boom cancellation unit 24a, an arm cancellation unit 24b, and a bucket cancellation unit 24c.

Boom cancellation unit 24a cancels stroke restriction control by boom restriction unit 23a to allow piston 4ac of boom cylinder 4a to reach the stroke end. Arm cancellation unit 24b cancels stroke restriction control by arm restriction unit 23b to allow piston 4bc of arm cylinder 4b to reach the stroke end. Bucket cancellation unit 24c cancels stroke restriction control by bucket restriction unit 23c to allow piston 4cc of bucket cylinder 4c to reach the stroke end.

Stroke restriction control unit 23 and stroke restriction control cancellation unit 24 transmit a control signal to EPC valve 46 as appropriate to stop the spool of main valve 41 or to permit drive of the spool of main valve 41.

An operation portion 30 is operated by the operator. Operation portion 30 may be arranged in operator's cab 2a. Operation portion 30 may be arranged at a position where the operator who sits in operator's seat 2b can readily operate the operation portion. Operation portion 30 includes a monitor 31, a switch 32, and the like. Monitor 31 may be a touch panel. Switch 32 may be any switch such as a push button. Switch 32 may be provided, for example, in first control lever 25L and second control lever 25R.

The operator makes setting to activate or deactivate stroke restriction control by operating operation portion 30. Contents of operations onto operation portion 30 by the operator are inputted to a stroke restriction control setting unit 50. Stroke restriction control setting unit 50 provides input of setting as to execution or non-execution of stroke restriction control to controller 20.

Monitor 31 may perform a function as issuance apparatus 60. The warning may be issued to the operator by representation on monitor 31.

<Method of Controlling Work Machine>

Control for suppression of pistons 4ac, 4bc, and 4cc of the hydraulic cylinders reaching the stroke ends in the work machine (hydraulic excavator 100) constructed above will be described below.

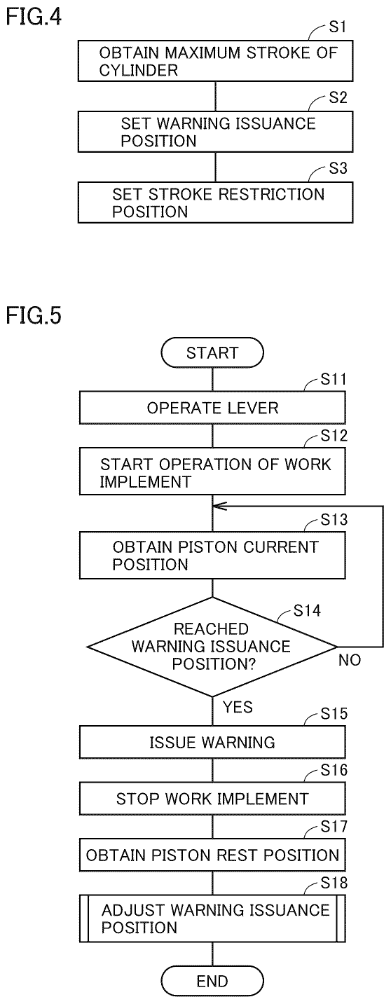

FIG. 4 is a flowchart showing a flow in advance preparation processing for control of the work machine. As shown in FIG. 4, initially, in step S1, controller 20 obtains a maximum stroke of the hydraulic cylinder. As described with reference to FIG. 3, boom calculator 21a calculates the maximum stroke of boom cylinder 4a based on the result of detection by stroke sensor 7a attached to boom cylinder 4a. Arm calculator 21b calculates the maximum stroke of arm cylinder 4b based on the result of detection by stroke sensor 7b attached to arm cylinder 4b. Bucket calculator 21c calculates the maximum stroke of bucket cylinder 4c based on the result of detection by stroke sensor 7c attached to bucket cylinder 4c.

In step S2, controller 20 sets a warning issuance position. Arm issuance unit 22b sets the warning issuance position before the stroke end by referring to the maximum stroke of arm cylinder 4b calculated in step S1. Arm issuance unit 22b sets the warning issuance position such that, when the operator recognizes the warning and stops the operation of arm 3b, a rest position of piston 4bc is as close as possible to the stroke end although piston 4bc does not reach the stroke end. Boom issuance unit 22a and bucket issuance unit 22c also similarly set the warning issuance position.

In step S3, controller 20 or specifically stroke restriction control unit 23 sets a stroke restriction position. The stroke restriction position is set as a position where the piston starts deceleration under intervention control by controller 20 to bring the piston to rest before it reaches the stroke end. The stroke restriction position is set between the warning issuance position and the stroke end. As the piston that moves toward the stroke end reaches the stroke restriction position, the piston starts deceleration. Advance preparation processing is thus performed.

(Adjustment of Warning Issuance Position Based on Skill Level of Operator)

Controller 20 in the embodiment is configured to adjust the warning issuance position based on the skill level of the operator and to change timing of issuance of the warning to the operator. FIG. 5 is a flowchart showing a flow of processing for adjusting the warning issuance position based on the skill level of the operator.

As shown in FIG. 5, in step S11, controller 20 receives input of an operation onto the control lever by the operator. As the operator operates first control lever 25L and/or second control lever 25R, operation amount sensor 26 senses a direction of operation and an amount of operation onto the lever. A signal indicating the direction of operation and the amount of operation onto the lever sensed by operation amount sensor 26 is provided to controller 20. In step S12, controller 20 starts operations of work implement 3 in accordance with the operation by the operator.

In step S13, controller 20 obtains the current position of the piston. Boom calculator 21a finds the current position of piston 4ac based on the result of detection by stroke sensor 7a or angle sensor 9a. Arm calculator 21b finds the current position of piston 4bc based on the result of detection by stroke sensor 7b or angle sensor 9b. Bucket calculator 21c finds the current position of piston 4cc based on the result of detection by stroke sensor 7c or angle sensor 9c.

In step S14, controller 20 determines whether or not the piston has reached the warning issuance position. Boom issuance unit 22a determines whether or not piston 4ac has reached a prescribed warning issuance position based on the current position of piston 4ac of boom cylinder 4a calculated by boom calculator 21a. Arm issuance unit 22b determines whether or not piston 4bc has reached a prescribed warning issuance position based on the current position of piston 4bc of arm cylinder 4b calculated by arm calculator 21b. Bucket issuance unit 22c determines whether or not piston 4cc has reached a prescribed warning issuance position based on the current position of piston 4cc of bucket cylinder 4c calculated by bucket calculator 21c.

When the piston is determined as not having reached the warning issuance position (NO in step S14), obtainment of the current position of the piston in step S13 and determination in step S14 are repeated.

When the piston is determined as having reached the warning issuance position (YES in step S14), the process proceeds to step S15 and the warning is issued to the operator. Warning issuance unit 22 outputs the control signal to issuance apparatus Issuance apparatus 60 that has received input of the control signal issues the warning to the operator by turning on indicator 61, sounding buzzer 62, or vibrating vibrator 63.

The operator who has recognized the warning decreases the amount of operation onto first control lever 25L and/or second control lever 25R. Typically, the operator moves his/her hand off first control lever 25L and/or second control lever 25R that the operator operated until now. Operation amount sensor 26 senses decrease in amount of operation onto first control lever 25L and/or second control lever 25R and inputs decrease in amount of operation to controller 20.

As controller 20 that has received input of the operation by the operator controls the opening of EPC valve 46 to decrease, variation in pilot pressure supplied to main valve 41 is lessened. As the operation of the spool of main valve 41 is suppressed and a moving speed of the piston of the hydraulic cylinder lowers, an operating speed of work implement 3 lowers. Typically, as controller 20 controls EPC valve 46 to fully be closed, the spool of main valve 41 stops moving. As the piston of the hydraulic cylinder comes to rest, the operation of work implement 3 stops (step S16).

In step S17, controller 20 obtains the rest position of the piston. Boom calculator 21a finds the rest position of piston 4ac based on the result of detection by stroke sensor 7a or angle sensor 9a. Arm calculator 21b finds the rest position of piston 4bc based on the result of detection by stroke sensor 7b or angle sensor 9b. Bucket calculator 21c finds the rest position of piston 4cc based on the result of detection by stroke sensor 7c or angle sensor 9c.

In step S18, controller 20 adjusts the warning issuance position as necessary to change timing of issuance of the warning.

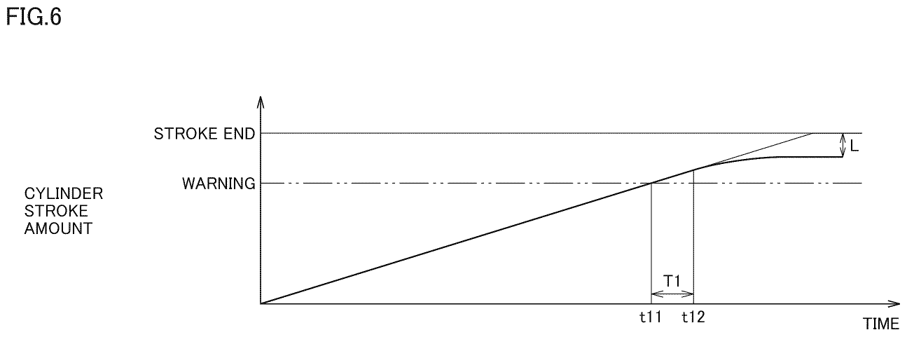

When the operator who recognized the warning takes time before the operator decreases the amount of operation onto the operation apparatus in spite of issuance of the warning in step S15, the piston may not be brought to rest before the stroke end but may reach the stroke end. Processing for adjusting warning issuance processing based on the skill level of the operator who operates hydraulic excavator 100 will be described with reference to FIG. 6 and FIGS. 7 and 8 which will be described later.

FIG. 6 is a diagram showing an exemplary operation when a warning is issued to a skilled operator. In FIG. 6 and FIGS. 7 and 10 to 12 which will be described later, the abscissa represents time and the ordinate represents a cylinder stroke amount, that is, a travel distance of the piston that moves toward the stroke end in the hydraulic cylinder.

As shown in FIG. 6, when the skilled operator operates hydraulic excavator 100, the warning is issued at time t11. The operator who has recognized the warning starts decrease in amount of operation onto operation apparatus 25 at time t12. A time period T1 has elapsed before the time of start of decrease in amount of operation onto operation apparatus 25 since the time of issuance of the warning. As a result of such an operation, the piston comes to rest at a position at a distance L from the stroke end. Distance L may be set, for example, to 10% of the maximum stroke.

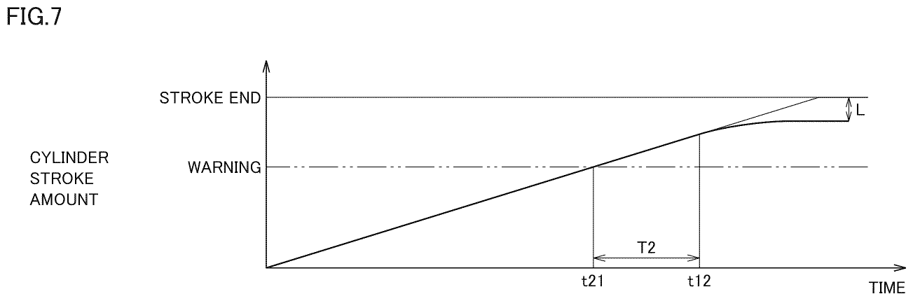

FIG. 7 is a diagram showing an exemplary operation when the warning is issued to a less experienced operator. In order to have the piston come to rest at the position at distance L from the stroke end as in the operation by the skilled operator shown in FIG. 6, decrease in amount of operation onto operation apparatus 25 should be started at time t12.

The less experienced operator does not immediately stop the operation onto operation apparatus 25 in spite of his/her recognition of the warning and requires a longer time period T2 before the time of start of decrease in amount of operation onto operation apparatus 25 since the time of issuance of the warning. Therefore, when the less experienced operator operates hydraulic excavator 100, the warning is issued at time t21 earlier than time t11 shown in FIG. 6. The warning issuance position shown in FIG. 7 is set at a position more distant from the stroke end than in FIG. 6.

The operator who operates hydraulic excavator 100 can adjust the warning issuance position to set timing of issuance of the warning as initial setting before start of the operation in accordance with his/her own skill level. As timing of issuance of the warning is set to come early in a case where the less experienced operator operates hydraulic excavator 100, the piston of the hydraulic cylinder reaching the stroke end can be suppressed and noise can be lowered.

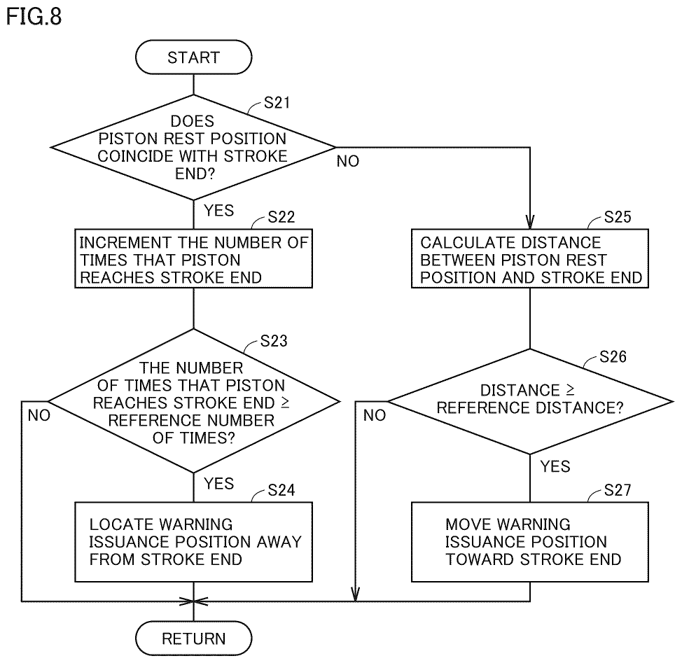

On the other hand, controller 20 can specify the skill level of the operator during works, and can automatically adjust the warning issuance position to change timing of issuance of the warning to the operator by feedback control based on the skill level of the operator. FIG. 8 is a flowchart showing a flow of processing in a sub routine for adjusting the warning issuance position in step S18 shown in FIG. 5.

In step S21, controller 20 determines whether or not the rest position of the piston obtained in step S17 coincides with the stroke end of the hydraulic cylinder.

When the rest position of the piston is determined as coinciding with the stroke end (YES in step S21), the process proceeds to step S22 and controller 20 increments the number of times that the piston reaches the stroke end. Controller 20 has the number of times that the rest position of the piston coincides with the stroke end stored in the memory in previous processing before start of the processing shown in FIG. 5. Controller 20 reads the number of times that the piston reaches the stroke end from the memory and performs processing for adding 1 to the number of times that the piston reaches the stroke end.

In step S23, controller 20 compares the incremented number of times that the piston reaches the stroke end and a prescribed reference number of times stored in the memory with each other and determines whether or not the number of times that the piston reaches the stroke end is equal to or larger than the reference number of times. When the number of times that the piston reaches the stroke end is equal to or

larger than the reference number of times (YES in step S23), determining that the operation resulting in bump of the piston against the stroke end was repeatedly performed in spite of issuance of the warning indicating approach of the piston of the hydraulic cylinder to the stroke end in step S15, controller 20 recognizes that the less experienced operator is operating hydraulic excavator 100. In this case, the process proceeds to step S24 and processing for advancing timing of issuance of the warning to adjust the warning issuance position away from the stroke end is performed.

When the number of times that the piston reaches the stroke end is smaller than the reference number of times (NO in step S23) in determination in step S23, processing for adjusting the warning issuance position is not performed but the process returns.

When the rest position of the piston is determined as not coinciding with the stroke end but determined as having come to rest before the stroke end (NO in step S21) in determination in step S21, the process proceeds to step S25 and controller 20 calculates a distance between the rest position of the piston and the stroke end.

In step S26, the controller compares the distance calculated in step S25 with a prescribed reference distance stored in the memory and determines whether or not the distance between the rest position of the piston and the stroke end is equal to or longer than the reference distance.

When the distance is equal to or longer than the reference distance (YES in step S26), determining that the operator who had recognized the warning issued in step S15 immediately stopped the operation onto operation apparatus 25 and consequently the piston came to rest at a position distant from the stroke end, the controller recognizes that the skilled operator is operating hydraulic excavator 100. In this case, the process proceeds to step S27, and processing for delaying timing of issuance of the warning to adjust the warning issuance position to be closer to the stroke end is performed.

When the distance is shorter than the reference distance (NO in step S26) in determination in step S26, processing for adjusting the warning issuance position is not performed but the process returns.

Controller 20 specifies the skill level of the operator who operates hydraulic excavator 100 based on the rest position of the piston after issuance apparatus 60 issued the warning. Controller 20 adjusts the warning issuance position based on the skill level of the operator.

As controller 20 changes timing of issuance of the warning to come earlier while the less experienced operator is operating hydraulic excavator 100, the piston of the hydraulic cylinder reaching the stroke end can be suppressed and noise can be lowered.

As controller 20 changes timing of issuance of the warning to come later while the skilled operator is operating hydraulic excavator 100, a distance from the position where the piston comes to rest until the stroke end can be shorter. As work implement 3 operates over a wider range of the maximum stroke of the hydraulic cylinder, efficiency in works can be improved.

As shown in FIGS. 6 and 7, time period T1 from recognition of the warning by the skilled operator until start of decrease in amount of operation onto operation apparatus 25 is relatively short whereas time period T2 from recognition of the warning by the less experienced operator until start of decrease in amount of operation onto operation apparatus 25 is relatively long. Therefore, controller 20 can specify the skill level of the operator based on a time period from the time of issuance of the warning until start of decrease in amount of operation onto operation apparatus 25.

For example, controller 20 can compare a time period from the time of issuance of the warning until start of decrease in amount of operation onto operation apparatus with a prescribed reference time period stored in the memory. When the time period is shorter than the reference time period, controller 20 can specify the operation as the operation by the skilled operator and can delay timing of issuance of the warning to bring the warning issuance position toward the stroke end. When the time period is longer than the reference time period, controller 20 can specify the operation as the operation by the less experienced operator and can advance timing of issuance of the warning to locate the warning issuance position away from the stroke end.

(Adjustment of Warning Issuance Position Based on Cylinder Speed)

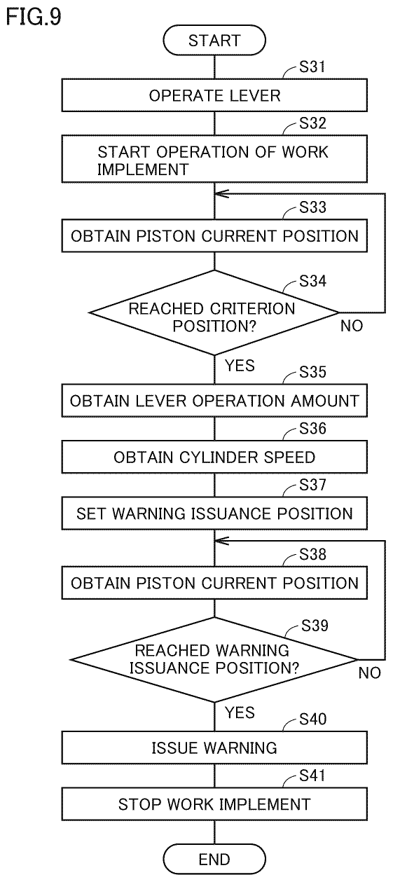

Controller 20 in the embodiment can adjust the warning issuance position to change timing of issuance of the warning to the operator by feedforward control based on a moving speed of the piston (which is referred to as a cylinder speed) toward the stroke end. FIG. 9 is a flowchart showing a flow of processing for adjusting the warning issuance position based on the cylinder speed.

As shown in FIG. 9, in step S31, controller 20 receives input of the operation onto the control lever by the operator. In step S32, controller 20 starts the operation of work implement 3 in accordance with the operation by the operator. In step S33, controller 20 obtains the current position of the piston. Processing in steps S31 to S33 is performed as in the processing in steps S11 to S13 shown in FIG. 5.

In step S34, controller 20 determines whether or not the piston has reached a criterion position. Warning issuance unit 22 determines whether or not the piston has reached a prescribed criterion position based on the current position of the piston of the hydraulic cylinder found by cylinder stroke calculator 21.

When the piston is determined as not having reached the criterion position (NO in step S34), obtainment of the current position of the piston in step S33 and determination in step S34 are repeated.

When the piston is determined as having reached the criterion position (YES in step S34), in step S35, controller 20 receives input from operation amount sensor 26, of the amount of operation onto first control lever 25L and/or second control lever 25R operated by the operator. In step S36, controller 20 calculates the cylinder speed in accordance with this amount of operation onto the lever. In step S37, controller 20 sets the warning issuance position based on the cylinder speed.

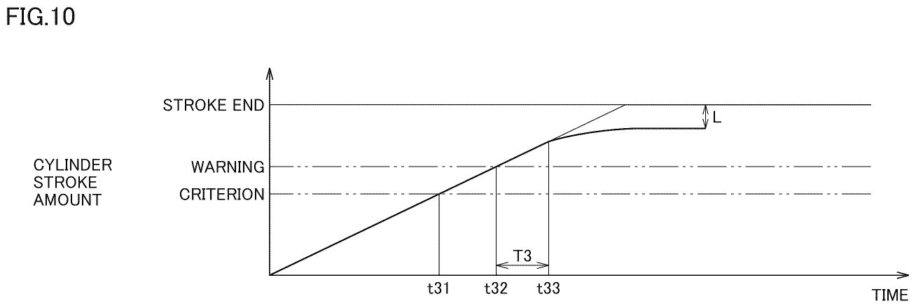

FIG. 10 is a diagram showing an exemplary operation when the cylinder speed is high. In step S36, the cylinder speed at time t31 when the piston reaches the criterion position is obtained. Since the amount of operation onto the lever is large and displacement of the lever from a neutral position is large when the cylinder speed is high, a time period from movement of the operator's hand off the lever until return of the lever to the neutral position is relatively long. Since a travel distance of the piston per unit time is long, the piston will have moved over a relatively long distance before the operator who recognized the warning decreases the amount of operation onto operation apparatus 25 after issuance of the warning.

Therefore, when the cylinder speed is high, controller 20 sets a position more distant from the stroke end as the warning issuance position. In an example in FIG. 10, the warning is issued at time t32. As the operator who has recognized the warning decreases the amount of operation onto operation apparatus 25, deceleration of the piston starts at time t33. A time period T3 has elapsed before the piston starts deceleration since the time of issuance of the warning. As a result of such operations, the piston comes to rest at a position at distance L from the stroke end.

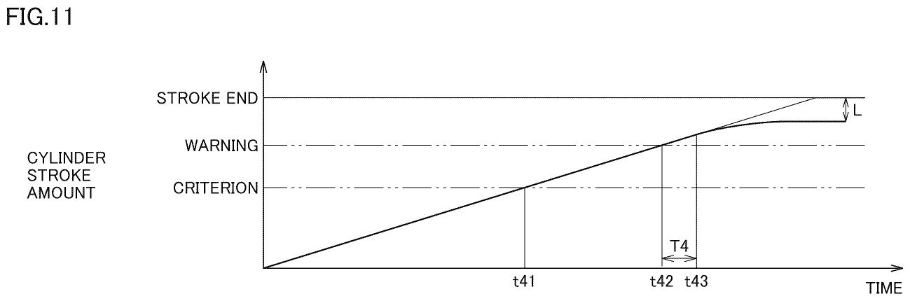

FIG. 11 is a diagram showing an exemplary operation when the cylinder speed is low. In step S36, the cylinder speed at time t41 when the piston reaches the criterion position the same as in FIG. 10 is obtained. Since the amount of operation onto the lever is small and displacement of the lever from the neutral position is small when the cylinder speed is low, a time period from movement of the operator's hand off the lever until return of the lever to the neutral position is relatively short. Since the travel distance of the piston per unit time is short, the travel distance of the piston before the operator who has recognized the warning decreases the amount of operation onto operation apparatus 25 after issuance of the warning is relatively short.

Therefore, when the cylinder speed is low, controller 20 sets a position closer to the stroke end as the warning issuance position. In an example in FIG. 11, the warning is issued at time t42. As the operator who has recognized the warning decreases the amount of operation onto operation apparatus 25, deceleration of the piston starts at time t43. A time period T4 has elapsed before the piston starts deceleration since the time of issuance of the warning. As a result of such operations, the piston comes to rest at the position at distance L from the stroke end as in FIG. 10.

Controller 20 adjusts the warning issuance position based on the cylinder speed at the time when the piston reaches the criterion position. When the cylinder speed is high, the travel distance of the piston before the piston starts deceleration after the time of issuance of the warning is relatively long. By setting the timing of issuance of the warning to come early when the cylinder speed is high, the piston of the hydraulic cylinder reaching the stroke end can be suppressed and noise can be lowered. When the cylinder speed is low, the travel distance of the piston before the piston starts deceleration after the time of issuance of the warning is relatively short. By setting timing of issuance of the warning to come later when the cylinder speed is low, work implement 3 can operate over a wider range of the maximum stroke of the hydraulic cylinder and hence efficiency in works can be improved.

Since processing in subsequent steps S38 to S41 shown in FIG. 9 is the same as the processing in steps S13 to S16 shown in FIG. 5, description thereof will not be provided.

(Stroke Restriction Control and Cancellation Thereof)

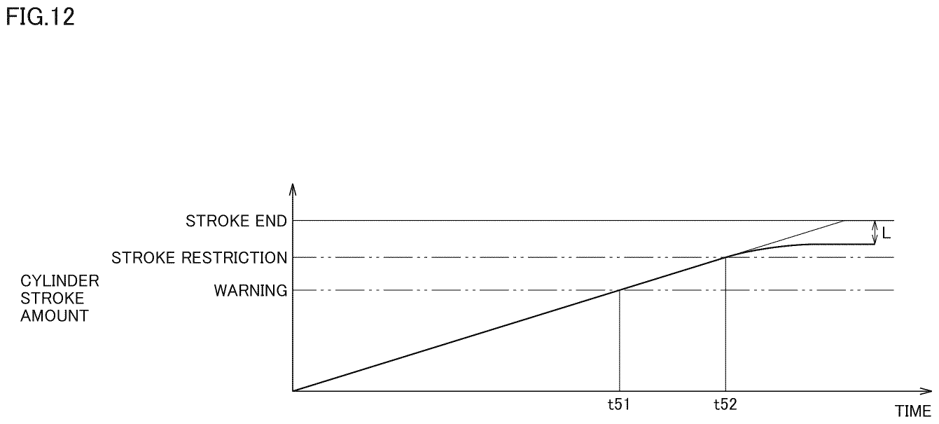

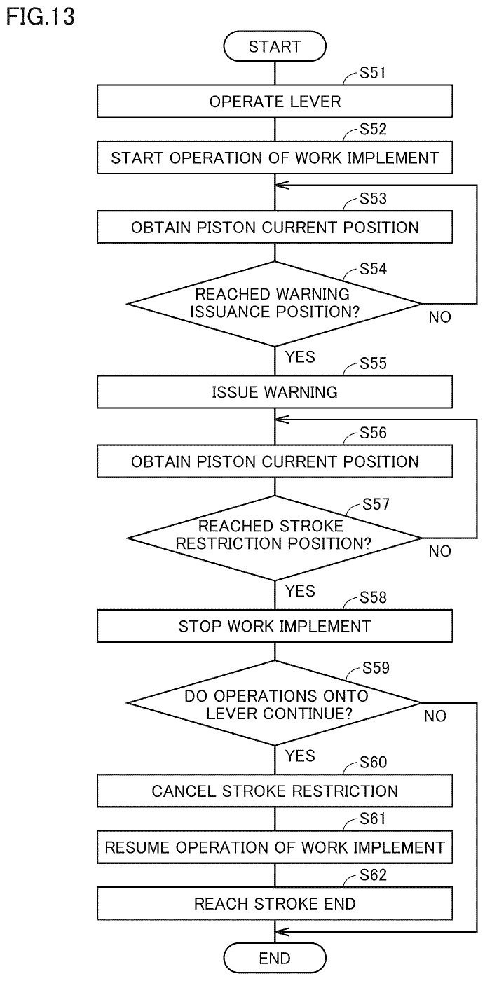

Stroke restriction control will now be described. FIG. 12 is a diagram showing an exemplary warning issuance position and an exemplary stroke restriction position.

As described already, stroke restriction control refers to intervention control by controller 20 to bring the piston of the hydraulic cylinder to rest before it reaches the stroke end. A stroke restriction position refers to a position between the warning issuance position and the stroke end that is set as a position where the piston starts deceleration under stroke restriction control.

In an example in FIG. 12, the warning is issued at time t51. The position that the piston reaches at time t52 after issuance of the warning is set as the stroke restriction position. When the piston reaches the stroke restriction position, the piston starts deceleration regardless of the operation onto operation apparatus 25 by the operator. Under stroke restriction control, the piston comes to rest at the position at distance L from the stroke end. Distance L shown in FIG. 12 may be set, for example, to 5% of the maximum stroke.

Control for canceling stroke restriction control for allowing the piston of the hydraulic cylinder to reach the stroke end in accordance with the operator's intention during works will now be described. FIG. 13 is a flowchart showing a flow of processing for canceling stroke restriction control in accordance with an operator's intention during works.

Since processing in steps S51 to S55 shown in FIG. 13 is the same as the processing in steps S11 to S15 shown in FIG. 5, description thereof will not be provided.

In step S56, controller 20 obtains the current position of the piston as in step S53.

In step S57, controller 20 determines whether or not the piston has reached the stroke restriction position. Stroke restriction control unit 23 determines whether or not the piston has reached a prescribed stroke restriction position based on the current position of the piston of the hydraulic cylinder found by cylinder stroke calculator 21.

When the piston is determined as not having reached the stroke restriction position (NO in step S57), obtainment of the current position of the piston in step S56 and determination in step S57 are repeated.

When the piston is determined as having reached the stroke restriction position (YES in step S57), in step S58, controller 20 carries out stroke restriction control. Stroke restriction control unit 23 transmits a control signal to EPC valve 46 to decrease the opening thereof so that the piston decelerates. As EPC valve 46 is closed to stop supply of pilot oil to main valve 41, the spool of main valve 41 stops moving. As the piston of the hydraulic cylinder comes to rest, the operation of work implement 3 stops.

After the piston comes to rest and work implement 3 stops under stroke restriction control, in step S59, controller 20 determines whether or not operations onto operation apparatus 25 by the operator continue. The operations onto operation apparatus 25 are sensed by operation amount sensor 26. Controller 20 determines whether or not the operations onto operation apparatus 25 continue based on whether or not it receives from operation amount sensor 26, input of a result of sensing indicating that operation apparatus 25 is being operated. When it is determined that the operations onto operation apparatus 25 do not continue (NO in step S59), the process ends as it is (end in FIG. 13).

When it is determined that the operations onto operation apparatus 25 continue (YES in step S59), controller 20 recognizes the continued operations onto operation apparatus 25 as indication of the operator's intention to further move the piston and cancels stroke restriction control in step S60. Stroke restriction control cancellation unit 24 outputs a control signal to instruct EPC valve 46 to open to the valve opening in accordance with the amount of operation onto operation apparatus 25 by the operator. As EPC valve 46 is controlled, pilot oil is supplied to main valve 41 and the spool of main valve 41 moves. As the piston of the hydraulic cylinder moves, the operation of work implement 3 resumes (step S61). As the piston reaches the stroke end (step S62), the process ends (end in FIG. 13).

Depending on contents of works such as soil removal works to drop off soil attached to bucket 3c by using impact resulting from piston 4cc of bucket cylinder 4c reaching the stroke end, intentional movement of the piston of the hydraulic cylinder to the stroke end may be desired. Such an operator's intention is recognized based on continued operations onto operation apparatus 25, and stroke restriction control is canceled. Since the operator can thus freely use the stroke end when the operator desires, workability can be improved.

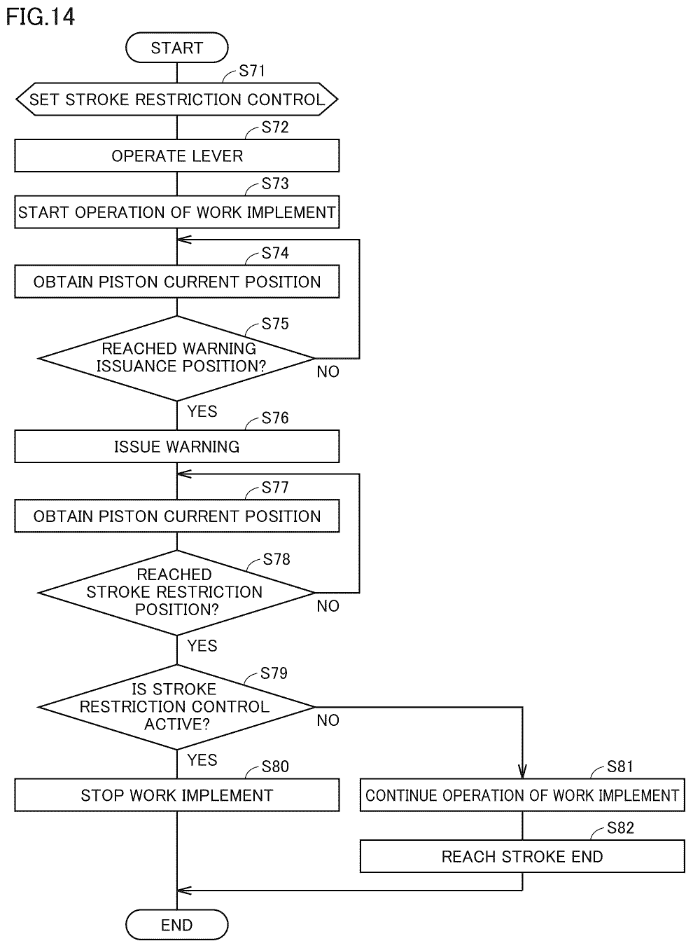

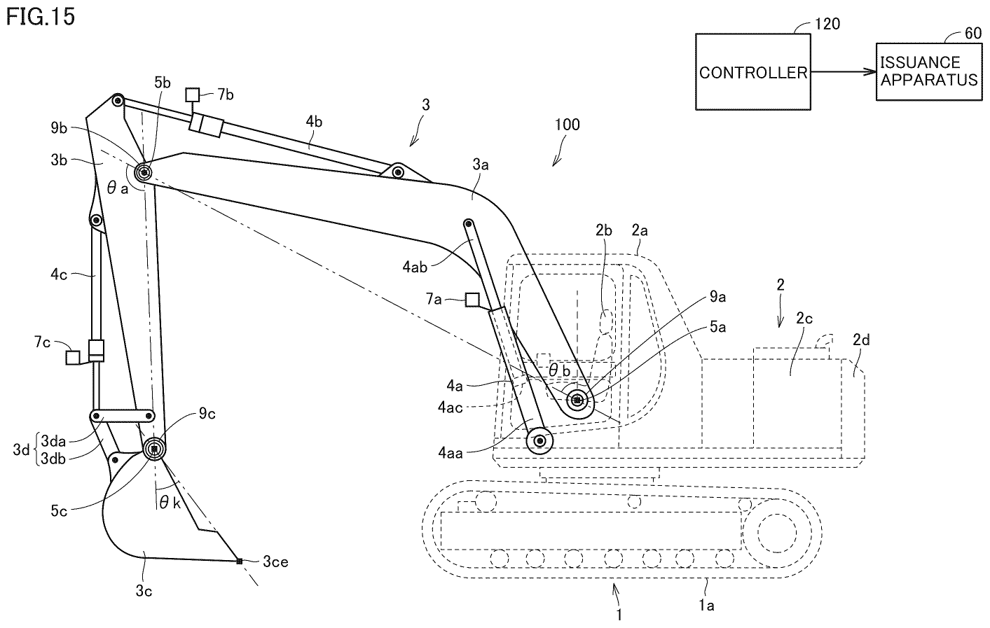

FIG. 14 is a flowchart showing a flow of processing for canceling stroke restriction control in accordance with advance setting made by the operator.

As shown in FIG. 14, in step S71, as preparation for works, the operator makes setting for stroke restriction control. The operator operates operation portion 30 or specifically operates monitor 31, switch 32, or the like. Operations by the operator are inputted to stroke restriction control setting unit 50 so that stroke restriction control setting unit 50 sets whether or not to carry out stroke restriction control. Stroke restriction control setting unit 50 provides this setting to controller 20.

For example, for a skilled operator, setting may be such that stroke restriction control is not carried out; the warning is issued when the piston reaches the warning issuance position but intervention control by controller 20 is not carried out. For example, for a less experienced operator, setting may be such that stroke restriction control is carried out; the piston is reliably prevented from reaching the stroke end under intervention control by controller 20 even when operations by the operator to decrease the amount of operation onto operation apparatus 25 are not sufficiently responsive at the time of issuance of the warning.

Since processing in steps S72 to S78 is the same as the processing in steps S51 to S57 shown in FIG. 13, description thereof will not be provided.

In step S79, controller 20 determines whether or not stroke restriction control is active. Controller 20 determines whether stroke restriction control is active or inactive in accordance with advance setting in step S71.

When stroke restriction control is active (YES in step S79), in step S80, controller 20 carries out stroke restriction control to stop operations of work implement 3. Then, the process ends (end in FIG. 14).

When stroke restriction control is not active (NO in step S79), in step S81, operations of work implement 3 continue in accordance with operations onto operation apparatus 25 by the operator. As the piston of the hydraulic cylinder reaches the stroke end (step S82), the process ends (end in FIG. 14).

By setting the configuration such that the operator is able to switch in advance between execution and stop of stroke restriction control by operating operation portion the operator can freely use the stroke end when the operator desires during works for removing soil from bucket 3c or the like, and hence workability can be improved.

The configuration may be such that switching between execution and stop of stroke restriction control shown in FIGS. 13 and 14 can be set for each hydraulic cylinder. Boom restriction unit 23a, arm restriction unit 23b, and bucket restriction unit 23c shown in FIG. 3 may be controllable independently of one another. Boom cancellation unit 24a, arm cancellation unit 24b, and bucket cancellation unit 24c shown in FIG. 3 may be controllable independently of one another. Stroke restriction control setting unit 50 may be able to set execution and non-execution of stroke restriction control individually for each of boom cylinder 4a, arm cylinder 4b, and bucket cylinder 4c.

For example, arm 3b may be under stroke restriction control so as to control piston 4bc of arm cylinder 4b not to reach the stroke end, whereas stroke restriction control for bucket 3c may be inactivated so that the operator is able to freely do works for removing soil from bucket 3c. By making such setting, generation of noise can reliably be suppressed and operability of work implement 3 can be improved.

In the embodiment so far, an example in which hydraulic excavator 100 includes controller 20 and issuance apparatus 60 and controller 20 mounted on hydraulic excavator 100 controls issuance apparatus 60 to issue a warning is described. Controller 20 and issuance apparatus 60 do not necessarily have to be mounted on hydraulic excavator 100.

FIG. 15 is a schematic diagram of a system including the work machine. A system in which a controller 120 arranged outside hydraulic excavator 100 receives, for example, signals indicating results of detection by stroke sensors 7a, 7b, and 7c from hydraulic excavator 100 and controls issuance apparatus 60 to issue a warning based on the signals may be constructed. Controller 120 and issuance apparatus 60 may be arranged at a work site of hydraulic excavator 100 or at a remote location distant from a work site of hydraulic excavator 100.

Though an embodiment has been described as above, features that can be combined in each embodiment may be combined as appropriate. It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

1 traveling unit; 2 revolving unit; 3 work implement; 3a boom; 3b arm; 3c bucket; 3ce cutting edge; 4a boom cylinder; 4aa, 4ba, 4ca cylinder portion; 4ab, 4bb, 4cb rod; 4ac, 4bc, 4cc piston; 4b arm cylinder; 4c bucket cylinder; 7a, 7b, 7c stroke sensor; 9a, 9b, 9c angle sensor; 20, 120 controller; 21 cylinder stroke calculator; 22 warning issuance unit; 23 stroke restriction control unit; 24 stroke restriction control cancellation unit; 25 operation apparatus; 25L first control lever; 25R second control lever; 26 operation amount sensor; 30 operation portion; 31 monitor; 32 switch; 41 main valve; 46 EPC valve; 50 stroke restriction control setting unit; 60 issuance apparatus; 61 indicator; 62 buzzer; 63 vibrator; 100 hydraulic excavator

1. A work machine comprising:
a vehicular body;
a work implement supported on the vehicular body;
a hydraulic cylinder that drives the work implement, the hydraulic cylinder including a cylinder portion and a piston capable of carrying out reciprocating movement within the cylinder portion;
an issuance apparatus that issues a warning; and
a controller that controls the hydraulic cylinder and the issuance apparatus, wherein
the controller
controls the issuance apparatus to issue a warning when the piston reaches a warning issuance position before a stroke end of the hydraulic cylinder, and
adjusts timing of issuance of the warning.

2. The work machine according to claim 1, wherein
the controller adjusts the warning issuance position to adjust the timing of issuance of the warning.

3. The work machine according to claim 2, wherein
the controller adjusts the warning issuance position based on a skill level of an operator who operates the work machine.

4. The work machine according to claim 3, further comprising an operation apparatus operated by the operator for driving the hydraulic cylinder, wherein
the controller specifies the skill level of the operator based on a time period from time of issuance of the warning until time of start of decrease in amount of operation onto the operation apparatus.

5. The work machine according to claim 3, wherein
the controller specifies the skill level of the operator based on a rest position of the piston after the issuance apparatus issues the warning.

6. The work machine according to claim 1, further comprising an operation apparatus operated by an operator for driving the hydraulic cylinder, wherein
the controller
carries out stroke restriction control to decelerate the piston when the piston reaches a stroke restriction position between the warning issuance position and the stroke end, and
cancels the stroke restriction control if an operation onto the operation apparatus continues after the piston comes to rest under the stroke restriction control.

7. The work machine according to claim 1, wherein
the controller carries out stroke restriction control to decelerate the piston when the piston reaches a stroke restriction position between the warning issuance position and the stroke end, and
the work machine further comprises an operation portion operated by an operator to switch between execution and stop of the stroke restriction control of the hydraulic cylinder.

8. The work machine according to claim 7, wherein
the work implement includes a boom rotatable with respect to the vehicular body, an arm rotatable with respect to the boom, and an attachment rotatable with respect to the arm,
the hydraulic cylinder includes a first cylinder that drives the arm and a second cylinder that drives the attachment, and
the controller individually makes switching between execution and stop of the stroke restriction control of the first cylinder and switching between execution and stop of the stroke restriction control of the second cylinder.

9. A system comprising:
a work machine including a vehicular body, a work implement supported on the vehicular body, and a hydraulic cylinder that drives the work implement, the hydraulic cylinder including a cylinder portion and a piston capable of carrying out reciprocating movement within the cylinder portion;
an issuance apparatus that issues a warning; and
a controller that controls the hydraulic cylinder and the issuance apparatus, wherein
the controller
controls the issuance apparatus to issue a warning when the piston reaches a warning issuance position before a stroke end of the hydraulic cylinder, and
adjusts timing of issuance of the warning.

10. A method of controlling an issuance apparatus, the issuance apparatus issuing a warning in connection with a work machine including a vehicular body, a work implement supported on the vehicular body, and a hydraulic cylinder that drives the work implement, the hydraulic cylinder including a cylinder portion and a piston capable of carrying out reciprocating movement within the cylinder portion, the method comprising:
controlling the issuance apparatus to issue a warning when the piston reaches a warning issuance position before a stroke end of the hydraulic cylinder, wherein
timing of issuance of the warning can be adjusted.
